(19) United States
(12) Patent Application Publication
(10) Pub. No.: US 2003/0014307 A1
(43) Pub. Date: Jan. 16, 2003

(54) Method and system for mobile commerce advertising

(75) Inventor: Teck T. Heng, Singapore (SG)

Correspondence Address: ANTHONY LUKE SIMON, General Motors Corporation, Legal Staff, 300 Renaissance Center, Mail Code 482-C23-B21, P.O. Box 300, Detroit, MI, 48265-3000, US

(73) Assignee: General Motors Corporation

(21) Appl. No.: 09/906,501

(22) Filed: Jul. 16, 2001

(51) Int. Cl. G06F 17/60

(52) U.S. Cl. 705/14

(57) ABSTRACT

The invention provides a method for mobile commerce advertising by receiving at least one mobile consumer transaction on a transaction server. The method then applies the mobile consumer transaction to at least one predefined customer account. Using the mobile consumer transaction and the predefined customer account, at least one customer profile is formed. The transaction server receives at least one vendor advertisement, and the vendor advertisement, along with the customer profile are used in creating a target list. The method then supplies the vendor advertisement to the predefined customer account.

### FIELD OF THE INVENTION

In general, the invention relates to the field of mobile commerce communication systems. More specifically, the invention relates to mobile commerce advertising and in particular, to target advertising of mobile commerce customers of proprietary financial institutions.

### BACKGROUND OF THE INVENTION

Database marketers have contributed significantly to the universal corporate goals of acquiring, retaining, and growing the value of a company's customers. Today, it is routine for firms to use customer transaction data to construct retail trade areas and consumer behavior profiles for the purpose of acquiring new customers. Retention programs enhanced by modeling are proactive and can be aimed directly at customers who show a propensity for using competitor services, in order to avoid reacting to customers who are long gone. Growth targets for existing customers are established, using real purchase data to spot potential up-sell and cross-sell opportunities.

The most critical step for database marketers, and for the measured marketing process, is to construct a strategy for linking point-of-sale transactions to the individual customer conducting the transaction. The large assortment of electronic payment media available is making it easier to close the loop between customers, sales, and stores. Proprietary and third party credit cards, frequency programs, and stored value cards are continuing to provide a key link.

Many leading firms are adopting new and unique ways to bridge the prior mentioned loop. Mobil or cellular phone technology is now capable of accessing e-commerce Internet sites in order to conduct consumer transactions. These phone systems however are expensive, and some consumers might prefer a simpler, less expensive alternative for mobile commerce. One of the more interesting alternatives in use today is Mobil Oil's Speedpass.

The Speedpass uses radio or “transponder” frequencies in the same manner as many U.S. tollways do to speed up the toll collection process. Customers register with Mobil and indicate their preferred payment method (e.g. Visa, MasterCard, Mobil Card, etc.). To activate the pump dispenser, customers “wave” the key chain Speedpass device in front of the pump, and their transaction is authorized and recorded. This saves time at the pump for Mobil's customers, and provides Mobil with a valuable database of transactions regardless of a customer's preferred electronic media payment method. A problem arises however, if the customer wishes to use the device for alternative business purposes. Automatic toll and payment collection systems, including Mobil Speedpass, only work for the retail system that they were engineered compliant. This means valuable transaction information involving sales from merchants other then Mobil cannot be obtained from the Speedpass customers.

Another innovation in mobile commerce is the use of “Smart cards”, a small electronic device about the size of a credit card that contains electronic memory, and possibly an embedded integrated circuit (IC). Smart cards containing an IC are sometimes called Integrated Circuit Cards (ICCs). Smart cards are used for a variety of purposes, including storing a patient's medical records, storing digital cash, and generating network IDs (similar to a token). To use a smart card, to either pull information from it or add data to it, you need a smart card reader for contact smart cards. Contact smart cards have contacts to the semiconductor chip on the surface of the card in compliance with ISO Standard 7816. For contactless smart cards, with no contacts on the surface of the card, connection with the semiconductor is done by means of radio frequency transmission through the surface of the card. Regardless of which smart card type, smart cards often require users to download money into the card prior to transactions, making them more difficult and inconvenient to use. In addition, smart card purchasing parameters in memory can only be edited by the issuing agency, further restricting their use. Like the Speedpass transponder, the smart card inadequacies restrict its use for multiple vendors, thereby omitting valuable transaction information. Also, all of the above mentioned devices require output devices such as printers or monitors to view the transaction information prior to its confirmation, or to confirm that the embedded data correlates with the customer records. Further, these methods and systems have no ability to review customer transaction information from multiple merchants, nor to view or take advantage of multiple merchant advertising.

Therefore, it would be desirable to have a method and system for mobile commerce advertising that provides adequate transaction information, and an interactive medium for customer purchasing and solicitation. Further, it would be desirable that an improved method and system for mobile commerce advertising provide for the complexities and problem previously mentioned.

### SUMMARY OF THE INVENTION

One aspect of the invention provides a method for mobile commerce advertising by receiving at least one mobile consumer transaction on a transaction server. The mobile consumer transaction is then applied to at least one predefined customer account. Using the mobile consumer transaction and the predefined customer account, at least one customer profile is formed. The transaction server next receives at least one vendor advertisement. The vendor advertisement along with the customer profile, are used in creating a target list, which is then used to supply the vendor advertisement to the predefined customer account.

Another aspect of the invention provides a system for mobile commerce advertising including a means for receiving at least one mobile consumer transaction on a transaction server, and a means for applying the mobile consumer transaction to at least one predefined customer account. Also included is a means for forming at least one customer profile as a function of the mobile consumer transaction and predefined customer account, and a means for receiving at least one vendor advertisement on the transaction server. Additionally included is a means for creating a target list as a function of the vendor advertisement and the customer profile, and a means for supplying the vendor advertisement to the predefined customer account as a function of the target list.

Another aspect of the invention provides a computer-usable medium storing a program that contains computer-readable program code for receiving at least one mobile consumer transaction on a transaction server, and computer-readable program code for applying the mobile consumer transaction to at least one predefined customer account. Also provided is computer-readable program code for forming at least one customer profile base on the mobile consumer transaction and predefined customer account, and computer-readable program code for receiving at least one vendor advertisement on the transaction server. Additionally provided is computer-readable program code for creating a target list as a function of the vendor advertisement and the customer profile, and computer-readable program code for supplying the vendor advertisement to the predefined customer account as a function of the target list.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a diagram of one embodiment of a mobile communication system in accordance with the invention;

FIG. 2 is a diagram of one embodiment of a mobile consumer transaction system for the mobile communication system of FIG. 1; and

FIG. 3 is a flowchart of a method of one embodiment of application for the mobile consumer transactions system of FIG. 2, in accordance with the invention.

### DETAILED DESCRIPTION OF THE PRESENTLY PREFERRED EMBODIMENTS

This invention can be used in conjunction with a separate patent filing titled “Method and Device for Conducting Mobile Commerce.” It can also be used with the broader mobile commerce strategy of a separate patent filing titled “Method and System for Conducting User Defined Mobile Commerce.” Further, this invention can be used with any mobile commerce system that provides for transactions involving multiple retailers recorded on a central server.

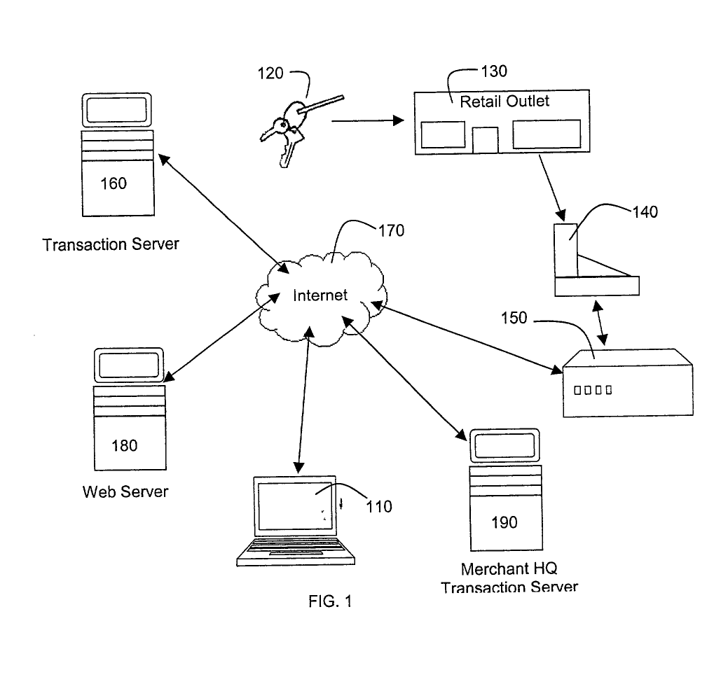

FIG. 1 illustrates a system 100 for mobile communications that is capable of performing the embodiments of the invention. The mobile communications system 100 may contain a user device 110 (transaction browser) capable of accessing and editing information via an Internet 170 connection. The transaction browser 110 may be a handheld personal digital assistant (PDA), a laptop computer, a personal computer (PC), a mobile telephone, or any other computer hardware and software device with Internet connectivity, browsing, and editing capabilities.

The transaction browser 110 can be used to edit a customer defined mobile commerce transaction account. The customer defined mobile commerce transaction account may be kept on a transaction server 160 in communication with the Internet 170. The transaction server 160 may be in communication with a customer (user) interface (websites and web pages) held on a web server 180, also in communication with the Internet 170. The customer interface may help users to conduct a variety of administrative tasks of the customer defined mobile commerce transaction account, such as monitoring the users transaction history, report loss of equipment, setting spending limits on the account, etc. The editable information may include, but is not limited to, personal user identifiers such as the users name and address, credit card information, banking account information, or self imposed credit limits on accessible accounts. In another embodiment of the mobile communications system 100, the transaction server 160 provides the functionality of the web server 180. This configuration will be used as a best mode for the present invention.

The transaction server 160 may be in communication with, or managed by, a financial institution or credit-authorizing agency, or it may be for an alternative organization or financial transaction system capable of providing user credit information and authorization for purchases. Additionally, the transaction server 160 can record and maintain a record of each transaction made by its customers. For one embodiment of the invention, the transaction data may be used to conduct targeted marketing of the transaction systems customers. The transaction data may be provided as marketing data via the Internet or other known marketing channels.

All prior mentioned customer account, transaction, and marketing information pointing to an individual account could also be referred to as user information. The user information may further be accessed with the aid of a wireless transponder device 120 (mobile transaction devise) in the form of a key fob or other handheld device, a car tag attached to some part of a car, or any other form capable of providing a predefined customer ID signal. Additional embodiments of the mobile communications system 100 may allow for customer ID information to be contained within a device to be accessed or “read” by an external device such as a credit card and card reader without using transponder technology.

The mobile transaction devise 120 may be in communication with a transaction provider (retailer, vendor) 130 equipped capable of accessing or receiving the customer ID information. The vendor 130 may be a retail outlet or other business, a consumer services provider such as for cable TV, Internet, or phone service, or any other commercial entity in accordance with the invention. The vendor 130 may be provided a compatible reader for the mobile transaction devise 120 from a transaction service provider and ‘signs on’ to a transaction service provided through a transaction server 160. Any provider of a mobile commerce system in accordance with the invention may be defined as a transaction service provider.

The vendor 130 may supply along with the application their intent for use of the mobile communications system 100, and upon acceptance and if applicable, may load proprietary software onto the vendors 130 point of sale equipment for communicating with the transaction server 160, and the web server 180, through the Internet 170. The point of sale equipment may include a cash register 140 that may be in communication with an Internet accessible device 150, for example a modem or network card. Additional, the device 150 may include transmitting and receiving (transceiver) capabilities. The vendor 130 may be in contact with their corporate transaction server (merchant HQ) 190 through the Internet 170 or other network connectivity known to the art. A transaction amount on the cash register 140 can be passed to the modem 150 along with a customer ID received from a transponder 120. The modem 150 may access the transaction server 160 through the Internet 170 and pass along the user ID, as well as the transaction information, and any additional pertinent information for the vendor 130. Dependent on the customer defined mobile commerce transaction account information; the transaction server 160 may provide an authorization for the transaction to be completed. If authorized, the transaction authorization may be passed through the Internet 170 in order to provide the information to the modem 150, and finally to the cash register 140 so the transaction can be completed. Additional embodiments of the mobile communications system 100 may add, delete, or exchange the above-mentioned items while remaining compliant with the present invention.

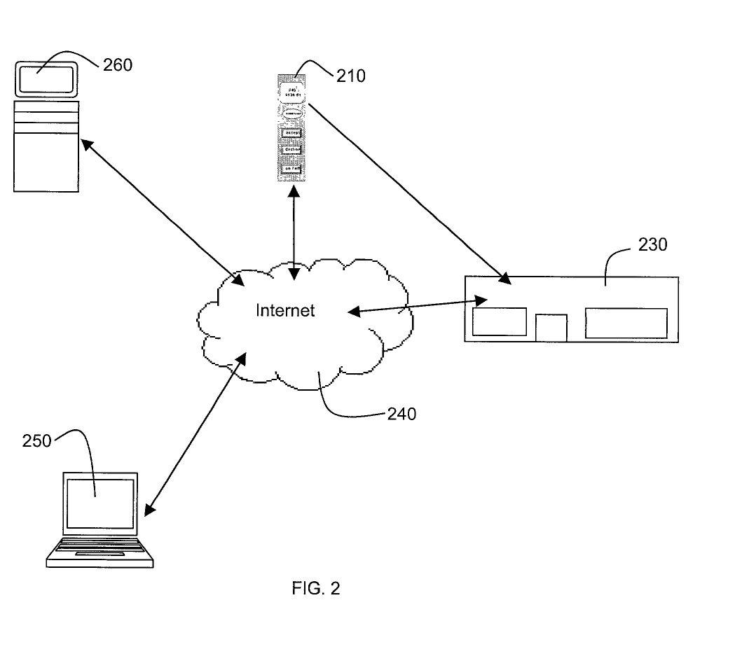

FIG. 2 is an illustration of a mobile consumer transaction system 200 in accordance with the present invention. The mobile consumer transaction system 200 can provide for mobile commerce advertising by combining all aspects of a sales transaction as is recorded by a transaction server 260. In one embodiment of the invention, a vendor 230 may receive a transaction request from a customer held mobile transaction device 210. The vendor 230 may transmit the request to a transaction service via the Internet 240. The transaction service can receive the request on its transaction server 260, and after checking that a customer account exists for the transaction, proceeds to accept the transaction data to a database in communication with the transaction server 260. An approved transaction response can be transmitted back to the vendor 230, and the completed transaction can be transmitted to the mobile transaction device 210.

Transactions that a customer makes using his/her account (whether linked to a transponder or some other transaction device) can be stored on the transaction server 260, or any other computer medium in communication with the transaction server 260, for the customer's perusal at a later date. The transaction information can be leveraged by a group of retailers who can conduct targeted promotions to these users.

An example of target marketing as conducted by the vendor 230 for one embodiment of the invention can include checking if a customer has visited a competing vendor over the past month, and has demonstrated a loyalty to the competing vendor. The vendor 230 may choose to target this customer for future promotions in order to induce a higher success rate. Vendors 230 may also target customers who appear to be loyal to a product or service.

In another embodiment of the invention, the vendor 230 may indicate to the transaction service through the transaction server 260, a customer profile that the vendor 230 would like to send out targeted promotional messages to.

An additional embodiment of the invention may provide promotional banners as are known in the art, or links to web pages to be linked to the customer account via an internet 240 accessible page that the customer can view on a browser 250. The customer can then click on the banner to access the promotion. By clicking on the banner, the transaction server may store the relevant promotion data for the customer to take advantage of later. The deadline for the customer to take advantage of the promotion may be noted in another embodiment of the invention, and a deadline date communicated to the customer over the Internet connected browser 250. The customer can then proceed to the vendor 230 locations to purchase the promotion if desired. During the purchase, any discounts can be automatically credited back to the customer's account by the transaction server 260. This may reduce the need for the customer to carry coupons to exercise various promotions.

In an alternative embodiment of the invention, the customer can be brought to a website with a picture or text of a coupon, which can be printed out and redeemed at the vendor 230 locations. A further embodiment may provide for additional features to the customer including a snapshot of active promotions either used or still active, as are stored on the transaction server 260 or its alternative. The snapshot may be viewed by the customer on the browser 250 via the Internet connection 240.

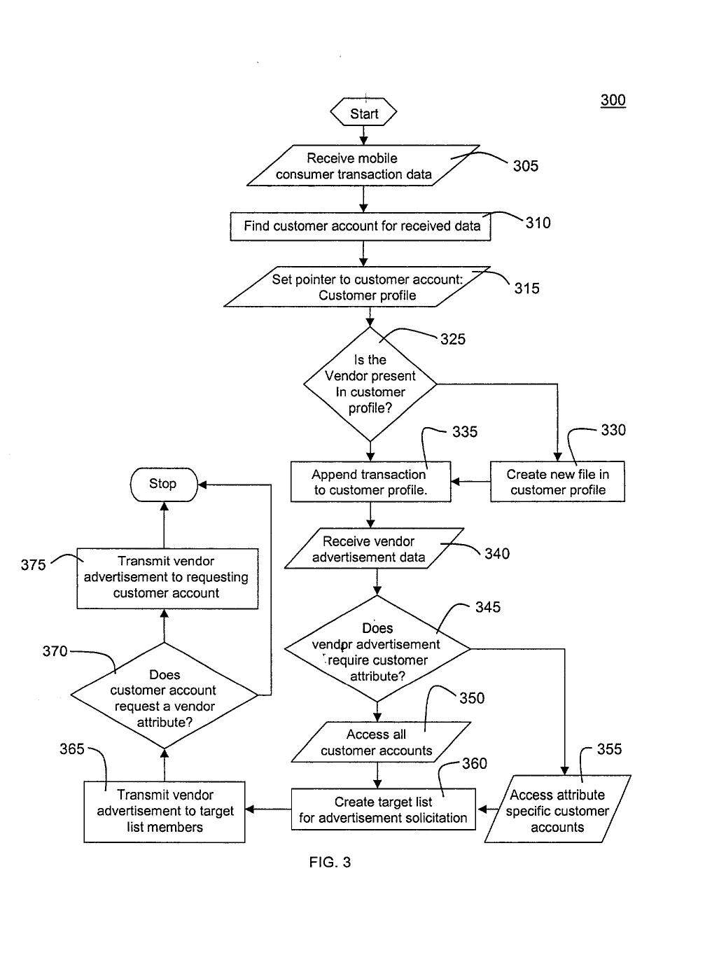

FIG. 3 is a flowchart illustration of a method for mobile commerce advertising 300 within a mobile commerce system 100 in accordance with the present invention. In one embodiment of the invention, at least one mobile consumer transaction is received by a transaction server. The received data 305 may be from one or many vendors and may be for one or many customers. The transaction server may search its database for a customer account or accounts that match the customer information 310 provided on the received transaction data 305. When a matching customer account is found, the transaction server may point to the found customer account and access the customer information 315. The customer information may include the customer account data, a customer purchasing profile (customer profile), customer defined parameters, and additional information as may be required for the invention.

Once the customer information has been accessed, one embodiment of the invention may check if the vendor listed in the transaction data is present in the customer profile 325. If not, the transaction server may create a folder or file for the vendor 330. Afterward, the method for mobile commerce advertising 300 may append the pertinent transaction information for each vendor into the appropriate vendor file within the customer profile 335.

Another embodiment of the invention may receive a vendor's request to advertise to the transaction server customers. To accomplish this, the vendor may transmit the request and its accompanying advertisement, as advertisement data to the transaction server 340. The advertisement data may contain a request by the vendor for one or more specific customer attributes to be searched for by the transaction server 345, thereby providing the targeting functionality of the invention. The attribute information may include personal customer information, geographic information, purchasing information, or any type or combination of information that may provide specific targeting of a group of customer accounts.

If customer attributes are requested by the vendor, the transaction server may sort through the customer accounts accessible to it, and sort out only the customer accounts that contain the requested attributes 355. If no attributes are requested by the vendor, the transaction server may provide all customer accounts to the vendor as suitable targeting profiles 350.

Another embodiment of the mobile commerce advertising 300 may create a target list 360 for further processing the vendor specific advertising information, from the customer accounts previously found suitable. For one embodiment of the invention, the target list may be copied to the vendors file, used as a program parameter, printed to a hard copy and/or copied to a computer medium and supplied to the vendor for their own distribution of advertisements and services, or the target list may be used in other forms required by the invention.

An additional embodiment may transmit the vendor advertisement data to the target list members 365. This may be in the form of e-mail, a printed copy, a web page ad or banner, an html image or icon, or other suitable form used for advertising mediums.

One embodiment of the invention may provide for a customer to place a request within its custom account data for specific vendor information or at least one vendor attribute that may be crosschecked 370 each time a vender transmits a new advertisement data. If a vendor advertisement data contains a customer account requested attribute the vendor advertisement may be sent in a method similar to the target list member transmissions, to the requesting customer account 375.

One of the preferred embodiments of the invention may contain an application or set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM), or downloaded via the Internet or other computer network. Thus, the present invention may be implemented as a computer program product for use in a computer and, furthermore, the computer medium that may embody the invention can include a transmission means. In addition, although the various methods described can be implemented in a general-purpose computer, one of ordinary skill in the art would also recognize that such methods may be carried out in hardware, in firmware, or in more specialized apparatus constructed to perform the required method steps.

The above mentioned actions and like procedures may be created using JAVA, C, C++, HTML, LISP, or other programming languages known in the art. The present invention may be embodied in other specific forms without departing from its spirit or essential characteristics. The described embodiments are to be considered in all respects only as illustrative and not restrictive. Further, the present invention may be embodied in other specific forms without departing from its spirit or essential characteristics. The described embodiments are to be considered in all respects only as illustrative and not restrictive.

We claim

1. A method for mobile commerce advertising comprising:
receiving at least one mobile consumer transaction on a transaction server;
applying the mobile consumer transaction to at least one predefined customer account;
forming at least one customer profile as a function of the mobile consumer transaction and predefined customer account;
receiving at least one vendor advertisement on the transaction server;
creating a target list as a function of the vendor advertisement and the customer profile; and
supplying the vendor advertisement to the predefined customer account as a function of the target list.

2. The method of claim 1 wherein the transaction server receives the mobile consumer transaction over the Internet.

3. The method of claim 1 further comprising receiving at least one customer profile attribute requirement within the vendor advertisement.

4. The method of claim 3 wherein the target list is restricted to customer profiles containing the attribute requirement.

5. The method of claim 1 further comprising providing a vendor advertisement attribute requirement within the customer profile.

6. The method of claim 5 wherein the target list is restricted to customer profiles containing the vendor advertisement attribute requirement that is present in the vendor advertisement.

7. The method of claim 1 further comprising transmitting to a transaction server, at least one mobile consumer transaction from at least one mobile transaction devise.

8. The method of claim 1 further comprising viewing the supplied vendor advertisement by a customer associated with the customer profiles, via a transaction browser.

9. The method of claim 1 further comprising providing the customer profile to a vendor.

10. The method of claim 9 wherein the target list is created by the vendor as a function of the customer profile.

11. The method of claim 1 wherein the vendor advertisement includes a promotional icon.

12. The method of claim 11 wherein the promotional icon provides a link for the customer profiles to access additional vendor advertisement features.

13. The method of claim 1 further comprising printing a hard copy of the vendor advertisement from the predefined customer account.

14. The method of claim 13 further comprising redeeming the hard copy of the vendor advertisement at a vendor retail outlet.

15. The method of claim 1 wherein the vendor advertisement remains with the predefined customer account for a predetermined period.

16. A system for mobile commerce advertising comprising:
means for receiving at least one mobile consumer transaction on a transaction server;
means for applying the mobile consumer transaction to at least one predefined customer account;
means for forming at least one customer profile as a function of the mobile consumer transaction and predefined customer account;
means for receiving at least one vendor advertisement on the transaction server;
means for creating a target list as a function of the vendor advertisement and the customer profile; and
means for supplying the vendor advertisement to the predefined customer account as a function of the target list.

17. The system of claim 16 further comprising means for receiving a customer profile attribute requirement within the vendor advertisement.

18. The system of claim 16 further comprising means for transmitting to a transaction server, at least one mobile consumer transaction from at least one mobile transaction devise.

19. A computer-usable medium storing a program, comprising:
computer-readable program code for receiving at least one mobile consumer transaction on a transaction server;
computer-readable program code for applying the mobile consumer transaction to at least one predefined customer account;
computer-readable program code for forming at least one customer profile base on the mobile consumer transaction and predefined customer account;
computer-readable program code for receiving at least one vendor advertisement on the transaction server;
computer-readable program code for creating a target list as a function of the vendor advertisement and the customer profile; and
computer-readable program code for supplying the vendor advertisement to the predefined customer account as a function of the target list.

20. The computer-usable medium of claim 19 further comprising computer-readable program code for receiving a customer profile attribute requirement within the vendor advertisement.

21. The computer-usable medium of claim 19 further comprising computer-readable program code for transmitting to a transaction server, at least one mobile consumer transaction from at least one mobile transaction devise.
